(19) United States
(12) Patent Application Publication
(10) Pub. No.: US 2010/0245908 A1
(43) Pub. Date: Sep. 30, 2010

(54) IMAGE COMMUNICATION APPARATUS, CONTROL METHOD THEREOF, AND STORAGE MEDIUM

(75) Inventor: Nobuyuki Tonegawa, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/729,610

(22) Filed: Mar. 23, 2010

(30) Foreign Application Priority Data
Mar. 26, 2009 (JP) 2009-076591
Mar. 2, 2010 (JP) 2010-045434

(51) Int. Cl. G06F 15/00

(52) U.S. Cl. 358/1.15

(57) ABSTRACT

An image communication apparatus that transmits input image data when detecting that a designated recipient has logged in an external apparatus. An MFP as an image communication apparatus includes a scanner for inputting image data and an operation unit for designating a recipient by whom the input image data should be received. When it is detected that the designated recipient has logged in another MFP which is a transmission destination of the input image data, the input image data is transmitted to the transmission destination MFP.

### BACKGROUND OF THE INVENTION

1. Field of the Invention

The present invention relates to an image communication apparatus for transmitting input image data, a control method of the image communication apparatus, and a storage medium.

2. Description of the Related Art

Conventionally, confidential communication has been known as a method for reliably sending confidential image data to a recipient without causing information leakage. In the confidential communication, a sender apparatus transmits image data after designating a storage area corresponding to a recipient. A receiver apparatus stores received image data in the designated storage area and outputs the image data on condition that a user corresponding to the storage area has logged in the receiver apparatus (i.e., if the user has been authenticated).

With the confidential communication, however, a problem is posed that a sender user is unable to confirm whether image data has been actually sent to the recipient. Specifically, whether the image data has been output is unknown, even if communication between the sender apparatus and the receiver apparatus has been normally completed and the image data has been stored into a memory of the receiver apparatus.

Thus, the receiver apparatus must keep storing the image data transmitted through confidential transmission until the recipient logs in the receiver apparatus and the image data is output, and therefore, there is a fear that the memory of the receiver apparatus is occupied for a long time.

Recently, to facilitate smooth communication between users, presence-related information has been used. For example, Japanese Laid-open Patent Publication No. 2005-318503 discloses a presence server that collectively manages users' log-in states in plural terminals. In response to an inquiry from a terminal, the presence server sends back to the terminal presence information indicating users' log-in states at other terminals.

With the technique disclosed in Japanese Laid-open Patent Publication No. 2005-318503, presence information at a terminal to which data is attempted to be transmitted can be acquired and provided to a sender apparatus user. Based on the presence information, the sender apparatus user is able to determine whether the intended recipient has logged in the destination terminal, thereby determining whether the data should be transmitted to the destination terminal.

However, even if presence information is used as in Japanese Laid-open Patent Publication No. 2005-318503, the following problem can be caused. Specifically, if the intended user has not logged in the destination terminal when the sender apparatus user attempts to transmit image data, the sender apparatus user has to wait until the recipient logs in the destination terminal or has to prompt by telephone, mail, or the like the recipient to log in the destination terminal, which provides extremely low usability for the sender apparatus user.

### SUMMARY OF THE INVENTION

The present invention provides an image communication apparatus that transmits input image data when detecting that a designated recipient has logged in an external apparatus, a control method of the image communication apparatus, and a storage medium.

According to a first aspect of this invention, there is provided an image communication apparatus, which comprises an input unit configured to input image data, a designation unit configured to designate a recipient by whom the input image data is to be received, a detection unit configured to detect, after the recipient is designated by the designation unit, that the designated recipient has logged in an external apparatus which is a transmission destination of the input image data, and a transmission unit configured to transmit the input image data to the external apparatus in a case where the detection unit detects that the designated recipient has logged in the external apparatus.

According to a second aspect of this invention, there is provided a control method of an image communication apparatus, which comprises an input step of inputting image data, a designation step of designating a recipient by whom the input image data is to be received, a detection step of detecting, after the recipient is designated in the designation step, that the designated recipient has logged in an external apparatus which is a transmission destination of the input image data, and a transmission step of transmitting the input image data to the external apparatus in a case where it is detected in the detection step that the designated recipient has logged in the external apparatus.

According to a third aspect of this invention, there is provided a computer-readable storage medium storing a program for causing a computer to execute the control method according to the second aspect of this invention.

According to a fourth aspect of this invention, there is provided an image communication apparatus, which comprises an input unit configured to input image data, a designation unit configured to designate a recipient by whom the input image data is to be received, a detection unit configured to detect that the designated recipient has logged in an external apparatus which is a transmission destination of the input image data, a transmission unit configured to transmit image data, and a log information recording unit configured to store a transmission result, wherein in a case where image data has normally been transmitted to the designated recipient by the transmission unit, a log indicating successful transmission is recorded in the log information recording unit if the detection unit has detected that the recipient has logged in the external apparatus, and a log that requests a sender' s attention is recorded in the log information recording unit if the detection unit has not detected that the recipient has logged in the external apparatus.

According to a fifth aspect of this invention, there is provided an image communication apparatus, which comprises an input unit configured to input image data, a transmission destination designation unit configured to input a transmission address to which the input image data is to be transmitted, and configured to designate an attribute representing whether the transmission address is equipment address or user address, a detection unit configured to detect that the designated recipient has logged in an external apparatus which is a transmission destination of the input image data, and a transmission unit configured to transmit image data, wherein in a case where the detection unit detects that a user has logged in, the transmission unit transmits the image data to an equipment address if the attribute designated by the transmission destination designation unit represents that the transmission address is equipment address, and transmits the image data to a user address if the attribute represents that the transmission address is user address.

According to a sixth aspect of this invention, there is provided an image communication apparatus, which comprises a receiver unit configured to receive image data, and a recipient user switching unit configured to set whether image data is to be received by using a URI of a log-in user or by using a URI of an equipment address, wherein image data is received in accordance with a setting by the recipient user switching unit.

With the present invention, it is possible to transmit input image data when detecting that a designated recipient has logged in an external apparatus.

Further features of the present invention will become apparent from the following description of exemplary embodiments with reference to the attached drawings.

### BRIEF DESCRIPTION OF THE DRAWINGS

FIG. 1 is a schematic view showing an image communication system according to a first embodiment of this invention;

FIG. 2 is a block diagram showing the construction of one of MFPs shown in FIG. 1;

FIG. 3 is a view showing a FAX transmission setting screen used for setting transmission conditions for FAX transmission made by the MFP by using a presence function of a presence server shown in FIG. 1;

FIG. 4 is a sequence diagram showing the procedures of FAX communication performed by the MFP by using the presence function;

FIG. 5 is a sequence diagram for explaining the procedures of image data transmission performed by the MFP in a case that a recipient has logged in a transmission destination MFP;

FIG. 6 is a view showing a message displayed on a destination monochrome MFP when a color image is ready for transmission from a color MFP to the monochrome MFP;

FIG. 7 is a sequence diagram for explaining the procedures of image data transmission in a case that a color image is ready for transmission from the color MFP to the monochrome MFP and that the recipient having logged out from the monochrome MFP has logged in another color MFP;

FIG. 8 is a flowchart showing a part of the procedures of a FAX transmission process performed by the MFP by using the presence function;

FIG. 9 is a flowchart following the flowchart of FIG. 8 and showing the remaining part of the procedures of the FAX transmission process;

FIG. 10A is a view showing an IP-FAX destination setting screen displayed on an operation unit of an MFP according to a second embodiment of this invention in a state where an equipment address is set as transmission destination information;

FIG. 10B is a view showing the IP-FAX destination setting screen in a state where a user address is set as the transmission destination information;

FIG. 11 is a view showing a presence function setting screen displayed on the operation unit of a receiver MFP for setting a SIP URI used when FAX is received by using the presence function;

FIG. 12 is a sequence diagram for explaining the procedures of image data transmission performed by using equipment name;

FIG. 13 is a sequence diagram for explaining the procedures of image data transmission in a case where a transmission time-out takes place;

FIG. 14 is a sequence diagram for explaining the procedures of image data transmission in a case where a user address is set as destination information;

FIG. 15 is a sequence diagram for explaining the procedures of image data transmission in a case where a user address is set as destination information and a transmission time-out takes place;

FIG. 16 is a flowchart showing the procedures of a FAX transmission process performed by the MFP to transmit a FAX by using the presence function; and

FIG. 17 is a flowchart showing the procedures of a FAX reception process performed by the receiver MFP to receive a FAX by using the presence function.

### DETAILED DESCRIPTION OF THE PREFERRED EMBODIMENTS

The present invention will now be described in detail below with reference to the drawings showing preferred embodiments thereof.

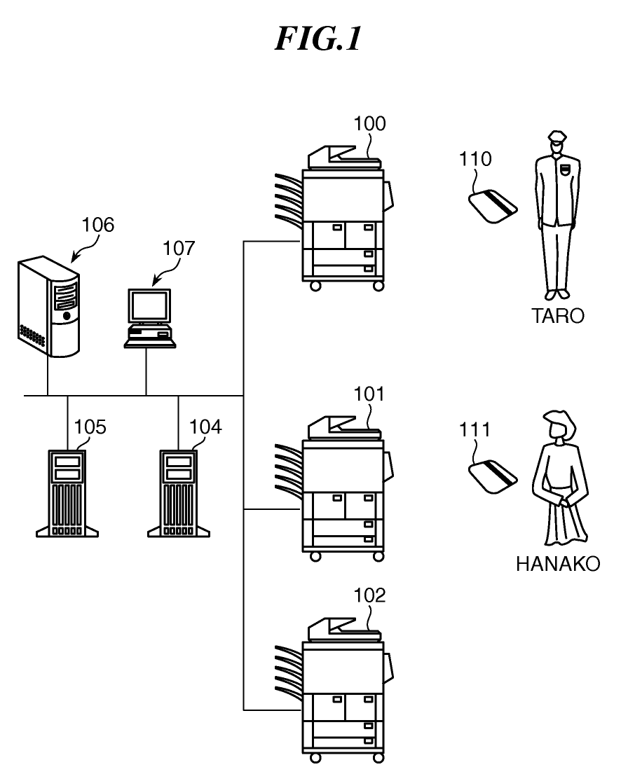

FIG. 1 schematically shows an image communication system according to a first embodiment of this invention. The image communication system is comprised of MFPs 100, 101, 102, a SIP server 104, a presence server 105, a mail server 106, and a mail client 107, which are connected to one another via a network.

The MFPs 100, 101, and 102, which are an example of image communication apparatuses, are multi-function copying machines each including a scanner and a printer and having, e.g., a copying function and a printer function for printing data created by a computer.

The SIP server 104 is a server that performs call control for communication under a SIP (session initiation protocol) stipulated in, e.g., RFC 2543. The presence server 105 as a management server that manages users' log-in states in the MFPs 100 to 102 has a presence function (attendance management), an instant message function, and a function of an expanded SIP protocol called SIMPLE (session initiation protocol for instant messaging and presence leveraging extensions).

The MFPs 100 to 102 are each SIP/SIMPLE compatible and able to communicate with the SIP server 104 and the presence server 105 under SIP and SIMPLE.

The MFP 100 is a color MFP comprised of a color scanner and a color printer and has an IP address of 172.168.0.100. The MFP 101 is a monochrome MFP comprised of a monochrome scanner and a monochrome printer and has an IP address of 172.168.0.101. The MFP 102 is a color MFP similar to the MFP 100 and has an IP address of 172.168.0.102.

A user TARO possesses an ID card 110 on which his own ID information is recorded. By using the ID card 110, TARO is able to log in a desired one of the MFPs to perform MFP operations allowed for him. In an e-mail transmitted by TARO, his e-mail address is set as transmission source information. In FAX transmission performed by using the presence function of the presence server 105, a SIP URI of sip:taro@abc.co.jp is set as transmission source information.

Similarly, a user HANAKO possesses an ID card 111 on which her own ID information is recorded. By using the ID card 111, HANAKO is able to log in a desired one of the MFPs to perform MFP operations allowed for her. In an e-mail transmitted by HANAKO, her e-mail address is set as transmission source information. In FAX transmission performed by using the presence function of the presence server 105, a SIP URI of sip:hanako@abc.co.jp is set as transmission source information.

The mail server 106 is a server that distributes, to other mail server or to the mail client 107, mail data distributed by using a SMTP protocol. The mail client 107 is implemented by a program running on a personal computer that transmits mail data created by a user or receives mail data.

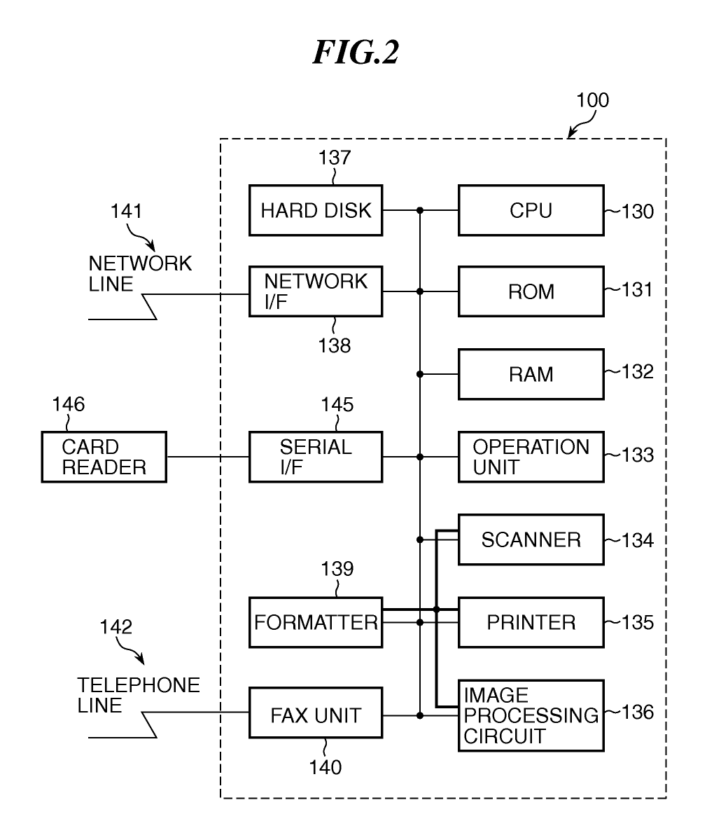

FIG. 2 shows in block diagram the construction of the color MFP 100. It should be noted that the monochrome MFP 101 and the color MFP 102 are basically the same in construction as the MFP 100, and a description thereof will be omitted.

In the MFP 100 shown in FIG. 2, a CPU 130 controls the entire MFP by using a program stored in a ROM 131 and by using a memory of a RAM 132.

An operation unit 133 is comprised of an LCD display panel and hard keys such as a start key and ten keys. The operation unit 133 displays software buttons on the LCD display panel and detects that a user touches any software button with finger, thereby enabling a smooth user operation.

A scanner 134 reads an image on an original and creates image data. A printer 135 prints an image on a recording medium based on image data.

An image processing circuit 136 is comprised of a large-capacity image memory, an image rotation circuit, a resolution conversion circuit, an encoding/decoding circuit for, e.g., MH, MR, MMR, JBIG, or JPEG encoding/decoding, and so on, and able to perform various image processing such as shading, trimming, and masking. A hard disk 137 is a large-capacity recording medium connected via an interface such as SCSI, IDE, or the like.

A network I/F 138 is a circuit that establishes a network data link for connection with a network line 141 such as Ethernet (registered trademark) typified by 10 BASE-T or 100 BASE-T, or token ring. A formatter 139 is a rendering circuit that creates an image to be printed by the printer 135.

In a case that PDL (page description language) data is received from a PC via the network I/F 138, image data is created from the received PDL data. The created image data is subjected to image processing by the image processing circuit 136, and resultant data is printed by the printer 135. The scanner 134, the printer 135, the image processing circuit 136, and the formatter 139 are connected with one another via a high-speed video bus other than a CPU bus extending from the CPU 130, whereby image data can be transferred at a high speed.

In the MFP 100, image data read by the scanner 134 is subjected to image processing by the image processing circuit 136, and the read image is printed by the printer 135, whereby a copy function is realized.

A FAX unit 140 controls facsimile communication with an external apparatus on the telephone line 142. Specifically, image data read by the scanner 134 is subjected to image processing by the image processing circuit 136 and resultant data is facsimile-transmitted to the external apparatus via the telephone line 142. Image data transmitted from the external apparatus is received and subjected to image processing by the circuit 136, and resultant data is printed by the printer 135.

A card reader 146 reads ID information from the ID card 110 or 111 held over the card reader. The read ID information is conveyed via a serial I/F 145 to the CPU 130. It should be noted that e.g., a user ID for identifying a user and a URL corresponding to the user are contained in the ID information to be read. It is possible not to make the user ID and the URL different from each other, and the URL may be used as the user ID.

Based on the ID information, the MFP 100 prohibits execution of color printing by a user not allowed to perform color printing. The MFP 100 utilizes a user address (e.g., user URL) for execution of e-mail transmission or for execution of FAX transmission performed by using the presence function of the presence server 105.

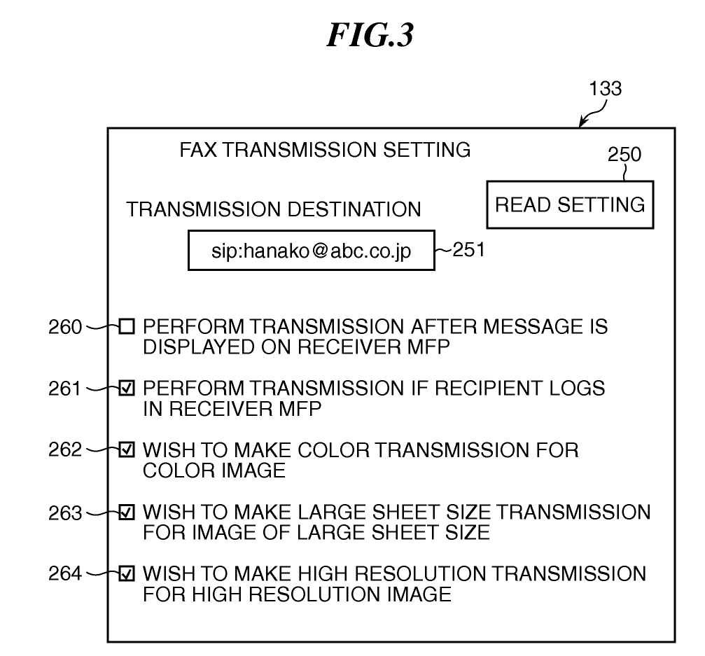

FIG. 3 shows a FAX transmission setting screen used for setting transmission conditions for FAX transmission performed by an MFP (e.g., the MFP 100) by using the presence function of the presence server 105, the setting screen being displayed on the LCD display panel of the operation unit 133 of the MFP.

By pressing a read setting button 250, resolution, density, and sheet size in reading an image by the scanner 134 can be set.

Destination information registered in an address book can be read and input to a transmission destination input field 251. Alternatively, a URL can directly be input to the field 251 by a user by using a keyboard of the operation unit 133. In this embodiment, different URLs are assigned to different users, and therefore, a desired recipient who should receive image data transmitted from the MFP 100 can be designated by inputting a corresponding URL to the transmission destination input field 251. In the example in FIG. 3, a URL of sip:hanako@abc.co.jp is input to the field 251, and hence a user HANAKO is designated as the recipient of image data.

Switches 260 to 264 are toggle switches for turning on/off setting items.

If a check mark is added to the switch 260, the MFP 100 operates to transmit a message (described later) to a receiver MFP before transmitting image data to the receiver MFP.

If a check mark is added to the switch 261, the MFP 100 operates to transmit image data after detecting that a recipient has logged in the receiver MFP (i.e., operates to transmit image data on condition that a designated recipient has logged in).

If a check mark is added to the switch 262 and if image data to be transmitted is a color image and a receiver MFP is not a color machine, the MFP 100 operates to display a message on the receiver MFP to inquire of a recipient about whether the recipient wishes to receive the image data.

If a check mark is added to the switch 263 and if image data to be transmitted is large in size such as A3 size and a receiver MFP is not compatible with such a large sheet size, the MFP 100 operates to display a message on the receiver MFP to inquire of a recipient about whether the recipient wishes to receive the image data.

If a check mark is added to the switch 264 and if image data to be transmitted is high in resolution such as 400×400 dpi and a receiver MFP is not compatible with such a high resolution, the MFP 100 operates to display a message on the receiver MFP to inquire of a recipient about whether the recipient wishes to receive the image data.

When transmission conditions are set on the FAX transmission setting screen and then a start key (not shown) is depressed, an image is read by the scanner 134 and then FAX transmission using the presence function of the presence server 105 is started by the MFP 100.

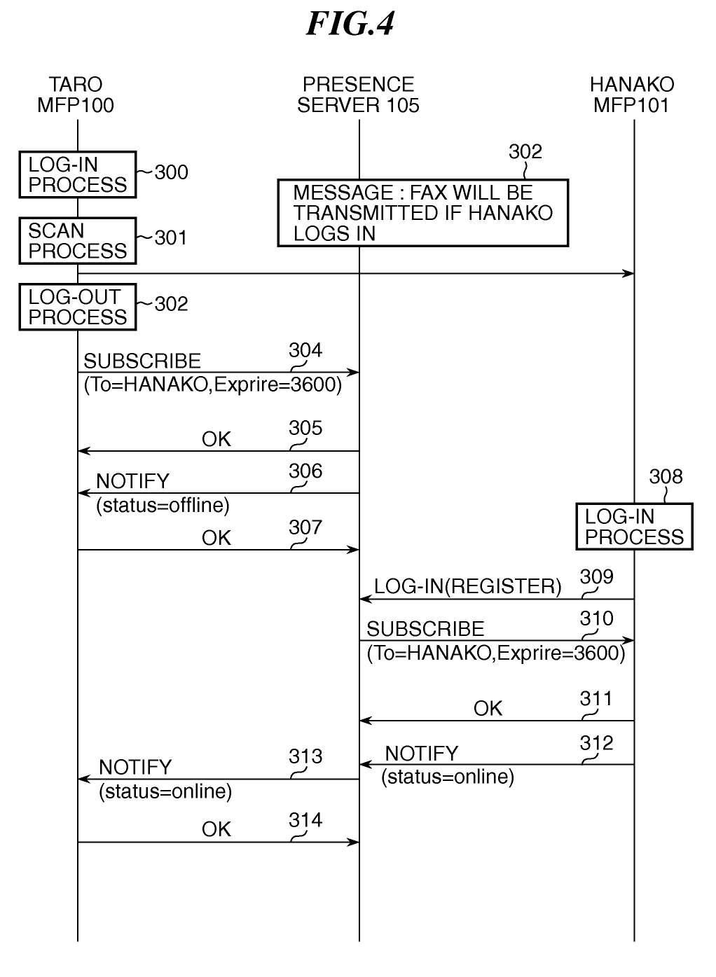

FIG. 4 shows in sequence diagram the procedures of FAX communication performed by the MFP 100 by using the presence function of the presence server 105.

When the user TARO touches his ID card 110 to the card reader of the MFP 100, a log-in process 300 is performed by the MFP 100. After logging-in the MFP 100, TARO performs FAX transmission settings shown in FIG. 3 and depresses a start button. In response to this, the MFP 100 performs a scan process 301 where an image to be transmitted is read by the scanner 134.

If a “perform transmission after message is displayed on receiver MFP” item is checked by the switch 260, the MFP 100 performs message transmission 302 where a message stating that “FAX will be transmitted if HANAKO logs in” is transmitted to the MFPs 101, 102 (only the MFP 101 is shown in FIG. 4). By making the message transmission 302, the MFP 100 requests the MFPs 101, 102 to output the message notifying HANAKO designated as recipient that there is image data ready for transmission. It should be noted that the MFP 100 may transmit only the URI character string of sip:hanako@abc.co.jp designated on the screen in FIG. 3, and the message can be created by each of the MFPs 101, 102 that receive the character string.

After completion of the scan process 301, when TARO logs out from the MFP 100, a log-out process 303 is performed by the MFP 100 and TARO completes using the MFP 100. Although the below-described processes 304 to 307 are performed in succession to the log-out process 303 in this example, these processes can be performed upon completion of the scan process 301.

The MFP 100 issues a SUBSCRIBE command 304 to the presence server 105 to request the server 105 to send back a notification if HANAKO will log in any of the MFPs 101 and 102 before elapse of available time of 3600 seconds.

The presence server 105 that receives the SUBSCRIBE command 304 sends back a normal response 305 to the MFP 100 and sends the MFP 100 a NOTIFY command 306 to provide offline notification that HANAKO has not logged in at this stage. In response to this, the MFP 100 sends back a normal response 307 to the presence server 105.

It is assumed that HANAKO goes to a place where there is the MFP 101 or 102 (the MFP 101 in this example) to utilize, e.g., a copy function of the MFP. The message 302 is displayed on the MFP 101.

When HANAKO logs in the MFP 101 by using her own ID card 111, the MFP 101 performs a log-in process 308 and issues to the presence server 105 a REGISTER command 309 indicating that HANAKO has logged in. The command 309 contains HANAKO's URL (hanako@abc.co.jp) read from the ID card 111 and the IP address of the MFP 101.

Next, the presence server 105 issues a SUBSCRIBE command 310 to the MFP 101. In response to this, the MFP 101 sends back to the presence server 105 a normal response 311 and a NOTIFY command 312 indicating that HANAKO has currently logged in.

The presence server 105 that receives the NOTIFY command 312 transmits to the MFP 100 a NOTIFY command 313 indicating that HANAKO has currently logged in. The MFP 100 sends a normal response 314 back to the presence server 105.

With the above procedures, after TARO logs out, the MFP 101 is able to detect that HANAKO logs in, even if HANAKO has not logged in the MFP 101 (or the MFP 102) when TARO logs in the MFP 100. Thus, it is unnecessary for TARO to keep logging in until HANAKO logs in.

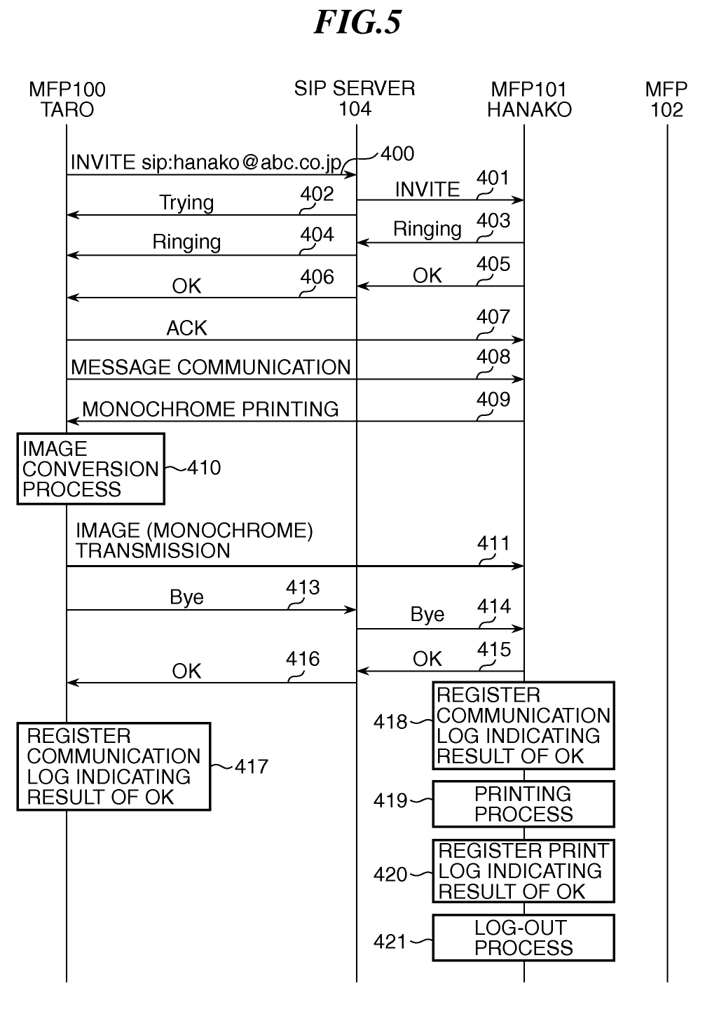

FIG. 5 shows in sequence diagram the procedures of image data transmission, which is started when the MFP 100 detects, according to the communication sequence shown in FIG. 4, that HANAKO logs in the MFP 100. In the following, a description will be given of a case where it is assumed that image data ready to be transmitted by the MFP 100 is color image and HANAKO logs in the MFP 101 that has not a color printing function.

First, the MFP 100 issues an INVITE command 400 to the SIP server 104. Since HANAKO has logged in the MFP 101 at that time, the SIP server 104 issues an INVITE command 401 to the MFP 101. This is accomplished by using the URL of hanako@abc.co.jp and the IP address of the MFP 101, which are registered in the SIP server 104 so as to correspond to each other according to the REGISTER command 309 previously notified to the server 104.

The SIP server 104 transmits to the MFP 100 a Trying command 402 indicating that the server 104 is now calling the MFP 101.

The MFP 101 that receives the INVITE command 401 sends back to the SIP server 104 a Ringing command 403 and an OK command 405 indicating that processing has normally been made.

In response to this, the SIP server 104 sends a Ringing command 404 and an OK command 406 to the MFP 100.

The MFP 100 that receives the OK command 406 understands that the MFP 101 is in a state capable of making data communication, transmits an ACK command 407, and carries out message communication 408.

In the message communication 408, the MFP 101 notifies the MFP 100 of pieces of information indicating whether the MFP 101 is able to process color image, maximum processable sheet size, resolution, processable compression system, MFP ability, etc. MFP ability information contained in the above data can be exchanged between MFPs during the message communication. Alternatively, MFP ability information can be exchanged by using MFP ability information contained in a SIP command data or by other method.

Based on the notified processing ability of the MFP 101, the MFP 100 determines whether image data ready for transmission will be able to be normally processed by the MFP 101. For example, it is determined that the image data will be unable to be normally processed by the MFP 101, if the image data ready for transmission is a color image and if the MFP 101 is not color-compatible.

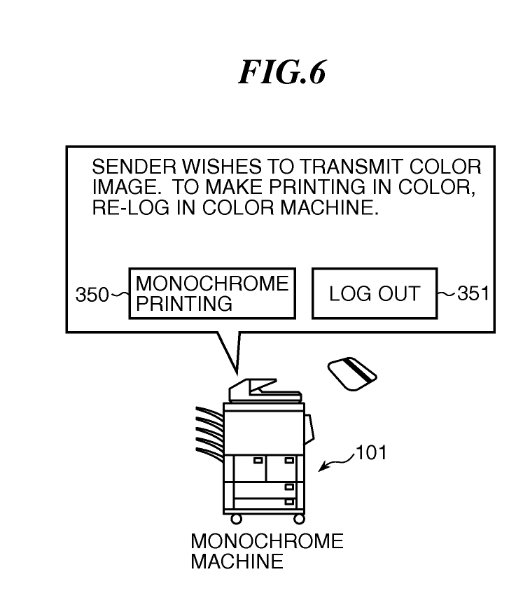

If it is determined that the image data ready for transmission will be unable to be normally processed by the MFP 101, the MFP 100 transmits, to the MFP 101 during the message communication 408, screen information for displaying a screen shown in FIG. 6. With the transmission of the screen information, the MFP 101 is requested to output a message to inquire of HANAKO about whether the image data should be received by the MFP 101.

FIG. 6 shows a message displayed on the monochrome MFP 101 in a case that data obtained by scanning a color original by the color MFP 100 or 102 is ready for transmission to the monochrome MFP 101. By displaying this message, it is possible to notify a recipient that a color image is ready for transmission from a sender and the color image will be able to be color-printed, if the recipient re-logs in a color machine.

When a monochrome print button 350 is depressed, it is indicated that monochrome printing is accepted, and therefore, a sender machine is requested to transmit image data in monochrome. On the other hand, when a log out button 351 is depressed, it is indicated that the recipient will log out from the currently logged monochrome machine and will re-log in another MFP (color machine) to receive the color image by the color machine.

It should be noted that by displaying a similar screen, it is possible to handle a case where the receiver machine does not support the size or the resolution of image data ready for transmission.

When the monochrome print button 350 is depressed, the MFP 101 notifies the MFP 100 of a monochrome printing command 409. The MFP 100 recognizes that the recipient wishes to receive monochrome data. Thus, the MFP 100 performs an image conversion process 410 to convert the color image into a monochrome image by using the image processing circuit 136, and transmits to the MFP 101 monochrome image data 411 obtained by the conversion.

After normally transmitting the image data 411, the MFP 100 transmits a Bye command 413 to the SIP server 104 which in turn transmits a Bye command 414 to the MFP 101. The MFP 101 that normally receives the image data 411 transmits an OK command 415 to the SIP server 104 which in turn transmits an OK command 416 to the MFP 100.

The MFP 101 performs a registration process 418 to register sip:TARO@abc.co.jp (as sender's SIP URI), sip:hanako@abc.co.jp (as recipient's SIP URI), reception start time, number of images, communication time, acceptance number, and reception result (OK) in a communication log.

Subsequently, the MFP 101 performs a printing process 419 to print the received image and a registration process 420 to register HANAKO (as typographer), print start time, number of prints, sheet size, image attribute (monochrome), and print result (OK) in a print log. After completion of the printing, the MFP 101 performs a log-out process 421 when HANAKO logs out from the MFP 101.

On the other hand, the MFP 100 performs a registration process 417 to register sip:TARO@abc.co.jp (as sender's SIP URI), sip:hanako@abc.co.jp (as recipient's SIP URI), transmission start time, number of images, communication time, acceptance number, and transmission result (OK) in a communication log.

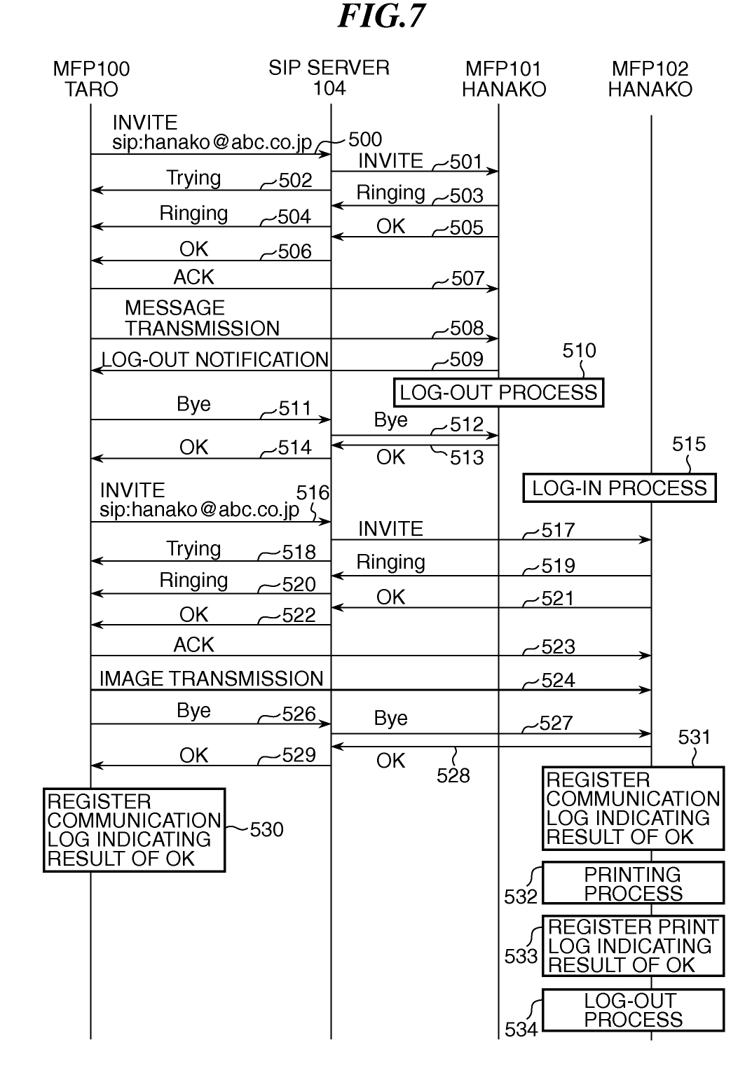

FIG. 7 shows in sequence diagram the procedures of image transmission in a case that a color image is ready for transmission from the color MFP 100 to the monochrome MFP 101 and a recipient re-logs in the color MFP 102 after depressing the log out button 351 displayed on the screen of the MFP 101 shown in FIG. 6.

First, the MFP 100 issues an INVITE command 500 to the SIP server 104. Since HANAKO has logged in the MFP 101 at that time, the SIP server 104 issues an INVITE command 501 to the MFP 101. This is accomplished by using the URL of hanako@abc.co.jp and the IP address of the MFP 101, which are registered in the SIP server 104 so as to correspond to each other according to the REGISTER command 309 previously notified to the server 104.

The SIP server 104 transmits to the MFP 100 a Trying command 502 indicating that the server 104 is now calling the MFP 101.

The MFP 101 that receives the INVITE command 501 sends back to the SIP server 104 a Ringing command 503 and an OK command 505 indicating that processing has normally been made.

In response to this, the SIP server 104 sends a Ringing command 504 and an OK command 506 to the MFP 100.

The MFP 100 that receives the OK command 506 understands that the MFP 101 is in a state capable of making data communication, transmits an ACK command 507, and performs message communication 508. In the message communication 508, a process similar to that in the message communication 408 described referring to FIG. 5 is performed.

When the log out button 351 is depressed, the MFP 101 transmits a log-out notification 509 to the MFP 100, and carries out a log-out process 510.

The MFP 100 transmits a Bye command 511 for log-out notification to the SIP server 104 which in turn transmits a Bye command 512 to the MFP 101. The MFP 101 transmits an OK command 513 to the SIP server 104 which in turn transmits to the MFP 100 an OK command 514.

When HANAKO logs in the MFP 102 after having logged out from the MFP 101, the MFP 102 performs a log-in process 515. As previously described referring to FIG. 4, the presence server 105 knows that HANAKO has logged in the MFP 102 and notifies the MFP 100 to that effect.

The MFP 100 notified of that HANAKO has logged in the MFP 102 issues an INVITE command 516 to the SIP server 104. Since HANAKO has logged in the MFP 102 at that time, an INVITE command 517 is issued from the SIP server 104 to the MFP 102.

The SIP server 104 transmits to the MFP 100 a Trying command 518 indicating that the server 104 is now calling the MFP 102.

The MFP 102 that receives the INVITE command 517 sends back to the SIP server 104 a Ringing command 519 and an OK command 521 indicating that processing has normally been performed.

In response to this, the SIP server 104 sends a Ringing command 520 and an OK command 522 to the MFP 100.

The MFP 100 that receives the OK command 522 understands that the MFP 102 is in a state capable of making data communication, transmits an ACK command 523, and performs image communication 524. It should be noted that information transmitted and received during the image communication 524 includes information on the ability of each MFP, and hence ability information is exchanged between the MFPs 100 and 102. The MFP 100 confirms that the MFP 102 is able to handle a color image, and decides that the image is to be transmitted in color.

The MFP 100 knowing that data communication has normally been completed transmits a Bye command 526 to the SIP server 104 which in turn transmits a Bye command 527 to the MFP 102.

The MFP 102 transmits an OK command 528 to the SIP server 104 which in turn transmits an OK command 529 to the MFP 100.

The MFP 102 performs a registration process 531 to register sip:TARO@abc.co.jp (as sender's SIP URI), sip:hanako@abc.co.jp (as recipient's SIP URI), reception start time, number of images, communication time, acceptance number, and reception result (OK) in a communication log.

Subsequently, the MFP 102 performs a printing process 532 to print the received image and a registration process 533 to register HANAKO (as typographer), print start time, number of prints, sheet size, image attribute (color), and print result (OK) in a print log. After completion of printing, the MFP 102 performs a log-out process 534 when HANAKO logs out from the MFP 102.

On the other hand, the MFP 100 performs a registration process 530 to register sip:TARO@abc.co.jp (as sender's SIP URI), sip:hanako@abc.co.jp (as recipient's SIP URI), transmission start time, number of images, communication time, acceptance number, and transmission result (OK) in a communication log.

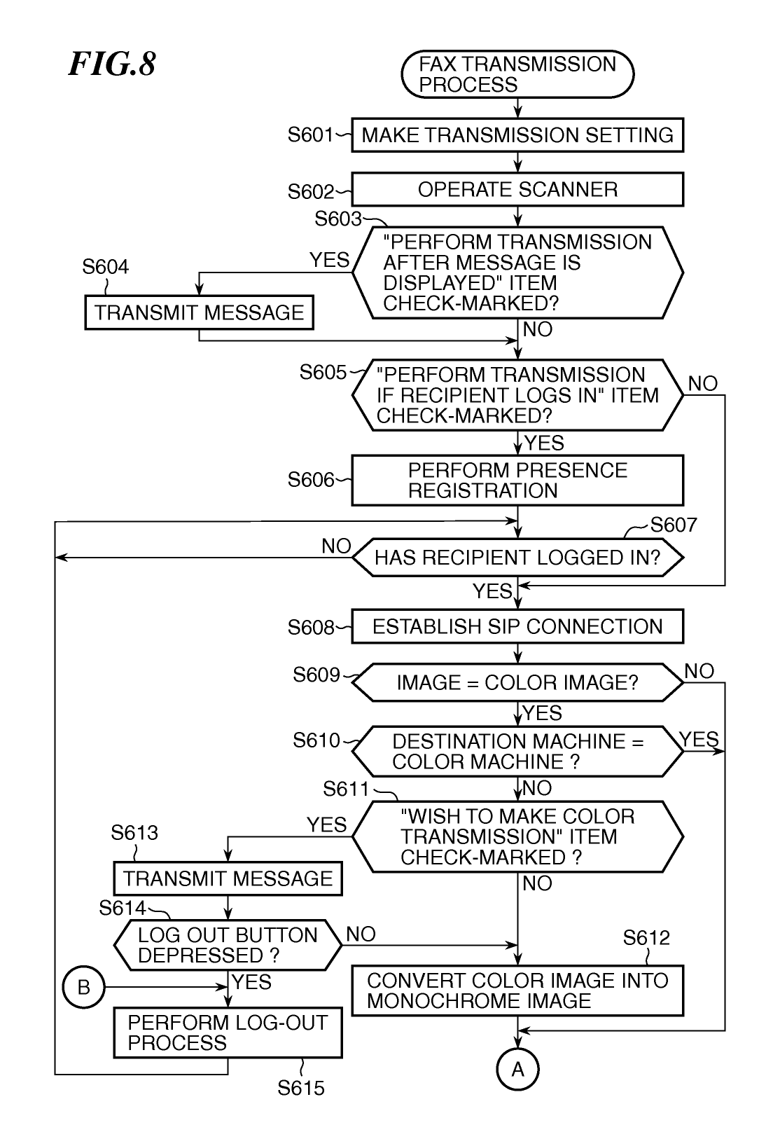

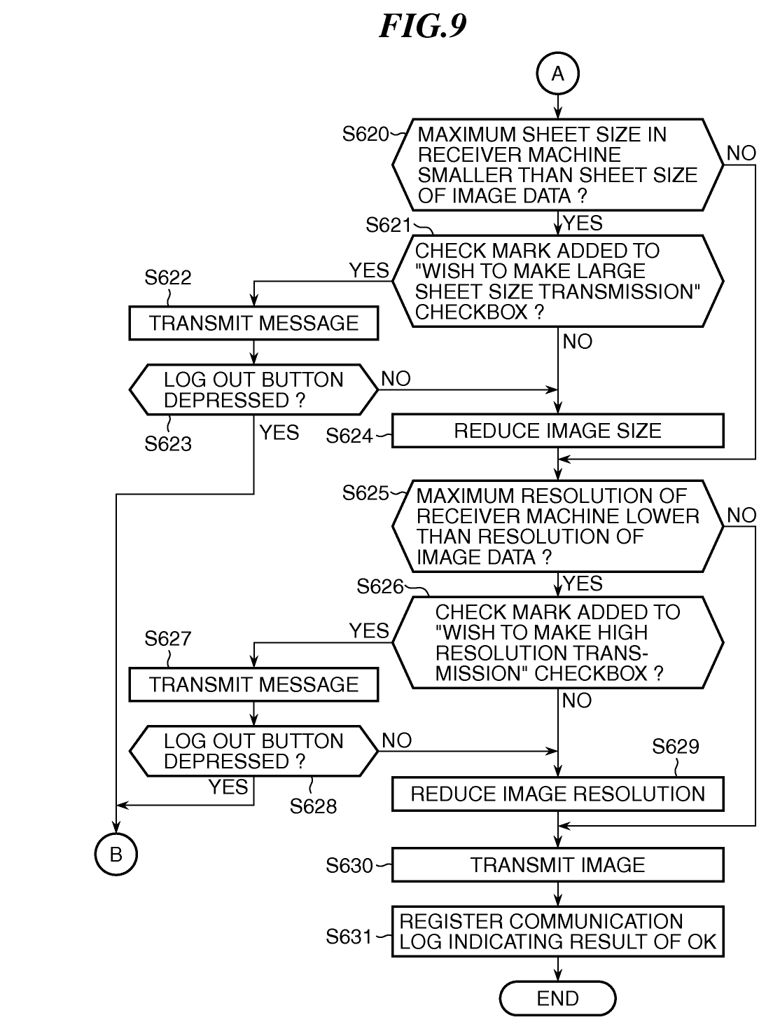

FIGS. 8 and 9 show in flowchart the procedures of a FAX transmission process performed by the MFP 100 to transmit image data by using the presence function of the presence server 105. Process steps (each denoted by a step number starting with the letter “S”) in the flowchart are executed by the CPU 130 of the MFP 100 by executing a predetermined control program.

A user is authenticated with the ID card by the MFP 100 and logs in the MFP 100. When the FAX transmission setting screen shown in FIG. 3 is selected by the user, the FAX transmission process is started.

In S601, transmission settings are made according to user's operation via the screen of the MFP 100 shown in FIG. 3. In S602, when a start button is depressed, the CPU 130 operates the scanner 134 to read image data.

In S603, the CPU 130 determines whether a “perform transmission after message is displayed on receiver MFP” item has been check-marked by the switch 260. If the item has been check-marked, the CPU 130 transmits, in S604 (first request unit), a message stating that “FAX will be transmitted if HANAKO logs in” to MFPs on the network (see, the message transmission 302 in FIG. 3).

In S605, the CPU 130 determines whether a “perform transmission if recipient logs in receiver MFP” item has been check-marked by the switch 261. The flow proceeds to S608 if the item has not been check-marked, and proceeds to S606 if the item has been check-marked.

In S606, the CPU 130 performs a presence registration (corresponding to the command 304 in FIG. 4) to request the presence server 105 to send back a notification if HANAKO (transmission destination) will log in another MFP.

In S607, the CPU 130 determines whether it receives from the presence server 105 a notification (corresponding to the command 313 in FIG. 4) to the effect that the recipient HANAKO has logged in another MFP. If the CPU receives the notification, the flow proceeds to S608.

In S608, the CPU 130 establishes a connection with the SIP server 104 and performs call control (corresponding to transmission/reception of the commands 400 to 407 in FIG. 5 or of the commands 500 to 507 in FIG. 7).

In S609, the CPU 130 checks whether the scanned image is a color image. If the image is a color image, the CPU 130 determines whether a transmission destination MFP (to which the recipient has logged in) is a color machine (S610).

If the transmission destination MFP is not a color machine, the CPU 130 checks whether a “wish to make color transmission for color image” item is check-marked by the switch 262 (S611). If the item is check-marked, the CPU 130 requests other MFPs to output the message as previously described referring to FIG. 6 (S613 (a second request unit)).

If it is determined in S614 that the log out button 351 is depressed, the CPU 130 performs a log-out process in S615 and the flow returns to S607. If it is determined in S614 that the monochrome print button 350 is depressed, the flow proceeds to S612.

In S612, the CPU 130 causes the image processing circuit 136 to convert the color image into a monochrome image, and the flow proceeds to S620 in FIG. 9.

In S620, the CPU 130 checks whether a sheet size that can be handled by the receiver machine is smaller than a sheet size of the image data ready for transmission. If the sheet size capable of being handled by the receiver machine is smaller than that of the image data, the flow proceeds to S621.

In S621, the CPU 130 determines whether a check mark is added by the switch 263 to a “wish to make large sheet size transmission for image of large sheet size” checkbox. If a check mark is added, the CPU 130 requests, in S622, other MFPs to output a message similar to but different in content from the message shown in FIG. 6.

If it is determined in S623 that the log out button 351 is depressed, the CPU 130 performs a log-out process in S615 and the flow returns to S607. If it is determined in S623 that reduced printing is selected, the flow proceeds to S624.

In S624, the CPU 130 causes the image processing circuit 136 to reduce the image size, and the flow proceeds to S625.

In S625, the CPU 130 checks whether the resolution capable of being received by the receiver machine is lower than the resolution of the image data ready for transmission. If the resolution capable of being handled by the receiver machine is smaller that of the image data, the flow proceeds to S626.

In S626, the CPU 130 determines whether a check mark is added by the switch 264 to a “wish to make high resolution transmission for high resolution image” checkbox. If a check mark is added, the CPU 130 requests, in S627, other MFPs to output a message similar to but different in content from the message shown in FIG. 6.

If it is determined in S628 that the log out button 351 is depressed, the CPU 130 performs a log-out process in S615 and the flow returns to S607. If it is determined in S628 that reduced printing is selected, the flow proceeds to S629.

In S629, the CPU 130 causes the image processing circuit 136 to reduce the image resolution. After completion of the resolution-reducing process, the CPU transmits a resultant image in S630.

In S631, the CPU 130 registers sip:TARO@abc.co.jp (as sender's SIP URI), sip:hanako@abc.co.jp (as recipient's SIP URI), transmission start time, number of images, communication time, acceptance number, and transmission result (OK) in a transmission log, and the FAX transmission process is completed.

With the above construction, input image data can be transmitted, if it is detected that a designated recipient has logged in an external apparatus. It should be noted that a case where the SIP server 104 and the presence server 105 are configured to be separated from each other has been described, but these servers can be constituted by the same server.

In the following, a description is given of a second embodiment of this invention.

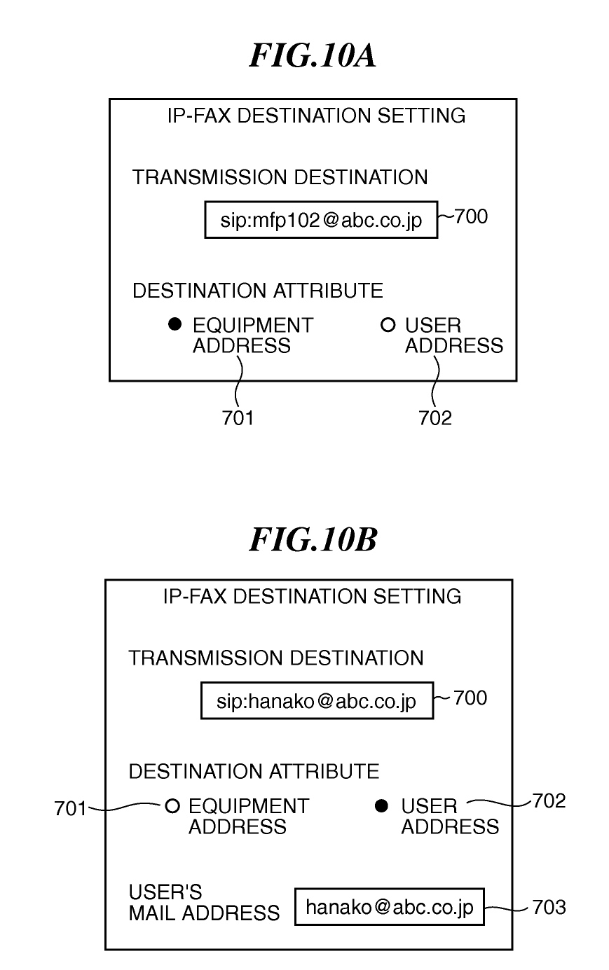

FIGS. 10A and 10B each show an IP-FAX destination setting screen (address book screen) for designating a transmission destination for IP-FAX communication stipulated by ITU-T.38, the setting screen being displayed on the LCD display panel of the operation unit 133 of, e.g., the MFP 100

When a transmission destination input field 700 is selected, a soft keyboard for inputting a transmission destination is displayed. For the communication using SIP protocol, a transmission destination is designated by SIP destination information. To this end, a destination of sip:mfp102@abc.co.jp is input to the field 700 in FIG. 10A, and a destination of sip:hanako@abc.co.jp is input to the field 700 in FIG. 10B.

If an equipment address is input to the transmission destination input field 700, a check button 701 is set ON. If a user address is input to the field 700, a check button 702 is set ON. These buttons 701, 702 are exclusively used. When either one of the buttons is selected, another button is in a non-selected state. In the example of FIG. 10A, an equipment address of sip:mfp102@abc.co.jp is set, and hence the check button 701 is set ON. In the example of FIG. 10B, user's (HANAKO's) address of sip:hanako@abc.co.jp is set, and the check button 702 is set ON.

When the check button 702 is set ON, an address setting field 703 for setting a mail address of the user set in the field 700 is displayed. In the example of FIG. 10B, HANAKO's mail address of hanako@abc.co.jp is set in the field 703.

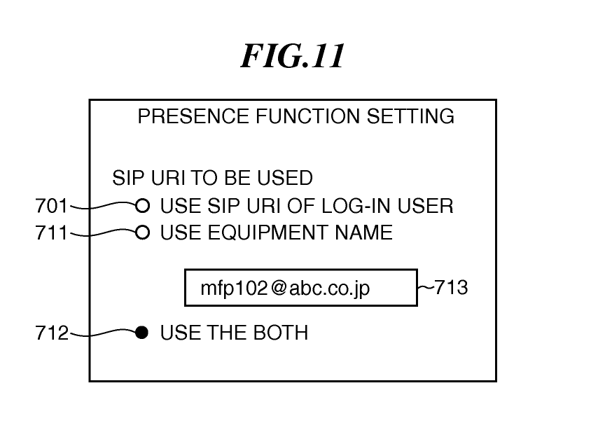

FIG. 11 shows a presence function setting screen used by a receiver machine (e.g., MFP 102) in the SIP protocol communication to set a SIP URI.

If a check button 710 is set ON, a URI of a log-in user is used for reception in the SIP communication. If a check button 711 is set ON, an equipment name (URI of equipment) set in a field 713 is used for reception in the SIP communication. If a check button 712 is set ON, both the SIP URI of the log-in user and the equipment URI are used for reception in the SIP communication.

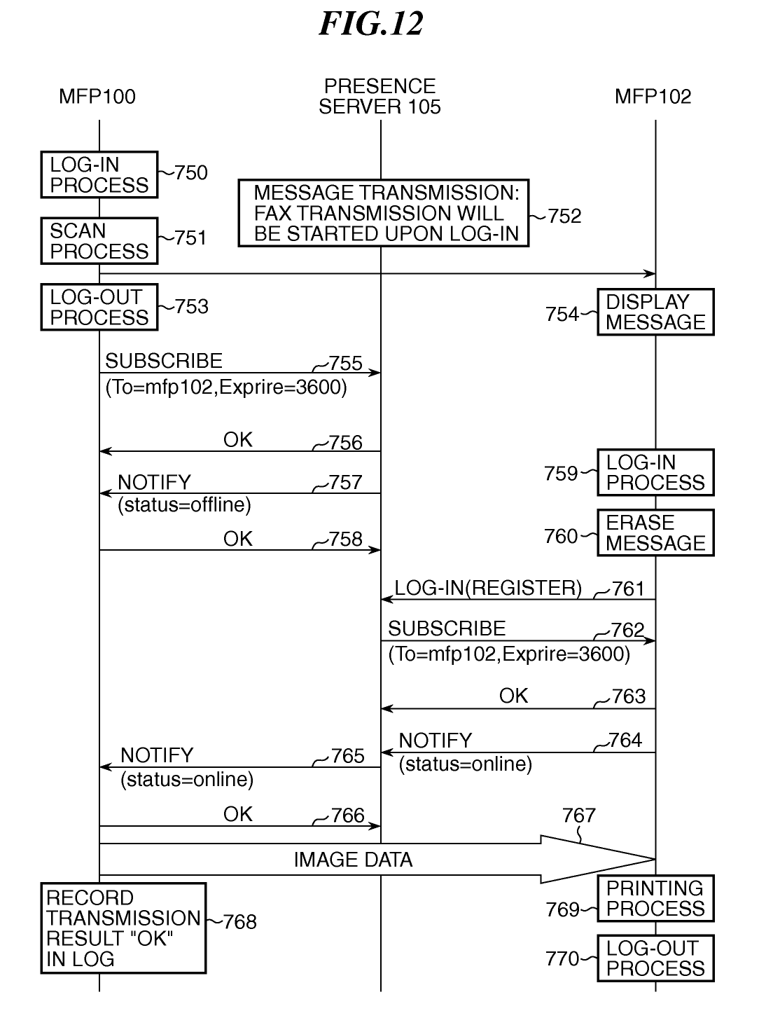

FIG. 12 shows in sequence diagram the procedures of image data transmission performed from the MFP 100 to the MFP 102 by using an equipment name (equipment URI).

It is assumed here that an equipment address “sip:mfp102@abc.co.jp” has been set as destination information and the “equipment address” checkbox 701 of destination attribute has been set ON as shown in FIG. 10A, and assumed that the “use equipment name” checkbox 711 has been set ON in the presence function setting (FIG. 11) for the MFP 102.

When a user holds an ID card over the MFP 100 or inputs a user name and/or a password to the MFP 100, the MFP 100 inquires of an authentication server (not shown) about whether the user is an authorized user. If the user is an authorized user, the MFP 100 performs a log-in process 750.

When the user designates the MFP 102 as a transmission destination and gives an instruction to start transmission, a scan process 751 is performed by the MFP 100. In the scan process 751, the scanner 134 is driven to read an image, and the read image is processed by the image processing circuit 136 to be converted into a transmittable image format.

After completion of the scan process 751, the MFP 100 performs message transmission 752 to transmit, to the MFP 102, a message stating that “FAX transmission will be started upon log-in” to prompt a recipient to log in, and the MFP 102 performs message display 754 to display the message. Instead of making the message display 754, a message can be printed or a lamp can be lit to notify the user of the MFP 102 that FAX can be received, whereby the same effect can be achieved.

When the sender user logs out, the MFP 100 carries out a log-out process 753 and issues a SUBSCRIBE command 755 to the presence server 105 to inquire whether a user represented by mfp102 has logged in, while giving available time of 3600 seconds.

The presence server 105 that receives the SUBSCRIBE command 755 sends back to the MFP 100 a response code 756 indicating that the command 755 has normally been accepted.

The presence server 105, confirming that the user represented by mfp102 has not logged in, sends back to the MFP 100 a NOTIFY command 757 to notify offline status where the user has not logged in.

The MFP 100 that receives the NOTIFY command 757 sends back to the presence server 105 a response command 758 indicating normal reception.

The user seeing the message display 754 on the MFP 102 becomes aware of the fact that FAX reception is possible. When the user logs in by presenting an ID card or by inputting a user name and/or a password, the MFP 102 performs a log-in process 759 as in the log-in process 750.

Next, the MFP 102 performs a message erase process 760 to erase the displayed message, and logs in the presence server 105 by sending a REGISTER command 761. It should be noted that since a “use equipment name” check button 711 is set ON for the MFP 102 and the equipment name (mfp102@abc.co.jp) of the MFP 102 is set in the field 713, the MFP 102 logs in by using the equipment name. If the “use the both” checkbox 712 is checked, the MFP 102 logs in by using both the log-in user name and the equipment name.

When a SUBSCRIBE command 762 is sent from the presence server 105, the MFP 102 sends back to the presence server 105 an OK command 763 indicating that command 762 has been received and a NOTIFY command 764 indicating that status information has been updated to online.

When knowing that the status information has been updated and the MFP 102 is in a log-in state, the presence server 105 sends to the MFP 100 a NOTIFY command 765 to notify that the MFP 102 is in a log-in state.

The MFP 100 sends back to the presence server 105 a response command 766 indicating that the command 765 has been received, and transmits image data 767 to the MFP 102.

The MFP 102 receives the image data 767 and performs a printing process 769 to print the image data 767. When the user picks up printed sheets and logs out, the MFP 102 performs a log-out process 770.

After normally transmitting the data to the receiver machine (MFP 102 in this example) during when the user (recipient) has logged in, the MFP 100 performs a recording process 768 to record a transmission result (OK) in a log, together with transmission year/month/day/time, required transmission time, transmission destination, number of pages transmitted, transmission data size, log-in user (sender) name, etc. If the MFP 100 is set to print a transmission result report, the MFP 100 prints a transmission result report in which a reduced image of a top page is shown together with the above-described pieces of information.

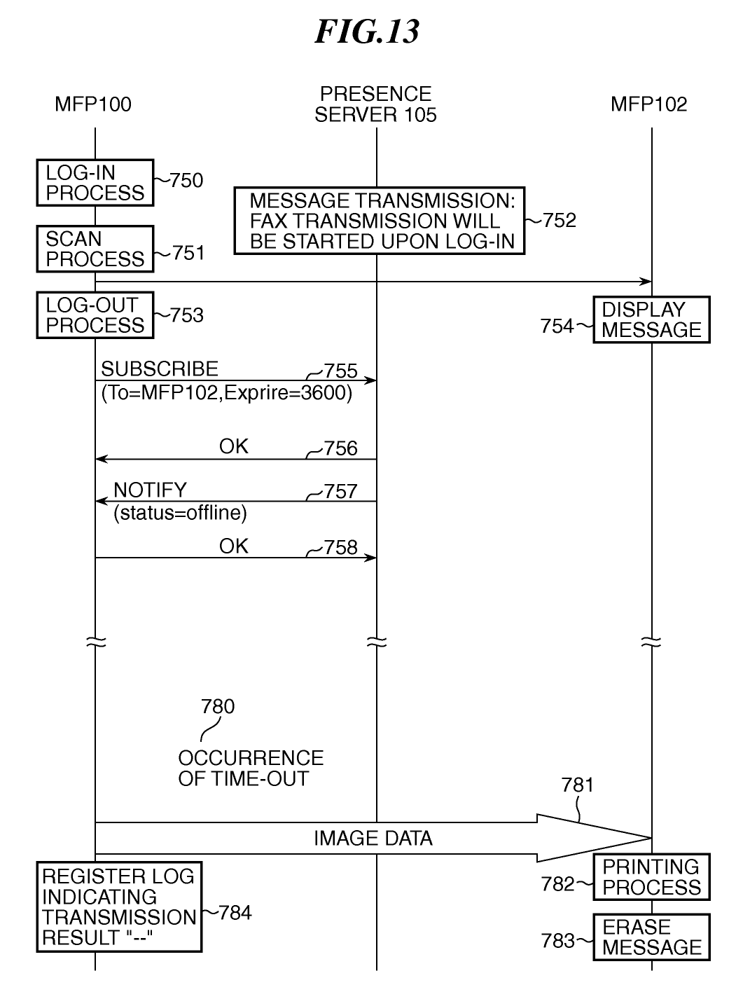

FIG. 13 shows in sequence diagram the procedures of image data transmission in a case that the MFP 100 attempts to transmit image data to the MFP 102, but a time-out takes place because a user has not logged in the MFP 102.

From a log-in process 750 to transmission of a response command 758, the MFP 100 and the presence server 105 perform the same operations as in the case described referring to FIG. 12.

If available time of 3600 seconds (=1 hour) specified by a SUBSCRIBE command 755 has elapsed without a recipient logging in despite a message being displayed on the MFP 102, a time-out takes place as shown at 780. When the time-out takes place, the MFP 100 transmits image data 781 obtained in the scan process 751 to the MFP 102.

The MFP 102 receives the image data 781 and performs a printing process 782 to print the image data and a message erase process 783 to erase the displayed message.

In that case, the data transmitted from the MFP 100 has been printed by the transmission destination MFP 102, but it is unknown for the MFP 100 whether the recipient who did not log in the MFP 102 got or will get the printed data. Thus, the MFP 100 performs a registration process 784 to register a log indicating a transmission result “--” (unknown) together with transmission year/month/day/time, required transmission time, transmission destination, number of pages transmitted, transmission data size, log-in user (sender) name, etc. The registration of the log that requests the sender's attention is advantageous in that the sender is able to subsequently confirm, where necessary, with the recipient about whether he/she normally received the data.

In the above example, the image data 781 is transmitted when the time-out takes place. Alternatively, upon occurrence of the time-out, the image data 781 can selectively be transmitted according to the setting of a selector switch for selecting transmission or non-transmission of image data. If non-transmission is selected by the selector switch, a log in which a transmission result “NG” is indicated is registered in the registration process 784. If the MFP 100 is set to print a transmission result report, the MFP 100 prints a transmission result report in which a reduced image of a top page is shown together with the above-described pieces of information.

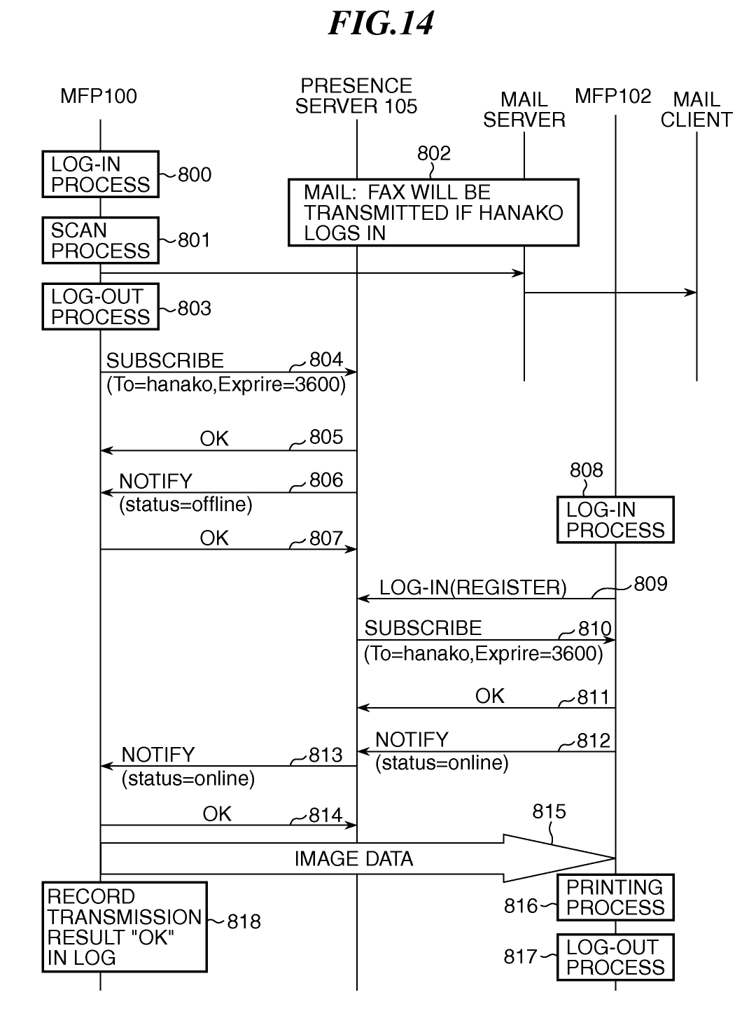

FIG. 14 shows in sequence diagram the procedures of image data transmission in a case that the user address is set as destination information and the “user address” checkbox 702 of destination attribute is set ON as shown in FIG. 10B.

When a user (sender) holds an ID card over the MFP 100 or inputs a user name and/or a password to the MFP 100, the MFP 100 inquires of an authentication server (not shown) about whether the user is an authorized user. If the user is an authorized user, the MFP 100 performs a log-in process 800.

When the user (sender) designates the user address “sip:hanako@abc.co.jp” of HANAKO as a transmission destination and gives an instruction to start transmission, a scan process 801 is performed by the MFP 100. In the scan process 801, the scanner 134 is driven to read an image, and the read image is processed by the image processing circuit 136 to be converted into a transmittable image format.

After completion of the scan process 801, the MFP 100 performs a mail transmission process 802 to transmit to HANAKO's mail address set in the address setting field 703 an e-mail stating that “FAX will be transmitted if HANAKO logs in” to prompt her to log in. The e-mail is transmitted from the MFP 100 via the mail server 106 to the mail client 107, which is set to be capable of receiving a mail directed to HANAKO.

When the sender user logs out, the MFP 100 carries out a log-out process 803 and issues a SUBSCRIBE command 804 to the presence server 105 to inquire whether HANAKO has logged in, while giving available time of 3600 seconds.

The presence server 105 that receives the SUBSCRIBE command 804 sends back to the MFP 100 a response code 805 indicating that the command 804 has normally been accepted. The presence server 105, confirming that HANAKO has not logged in, sends back to the MFP 100 a NOTIFY command 806 to notify offline status where the user has not logged in.

The MFP 100 that receives the NOTIFY command 806 sends back to the presence server 105 a response command 807 indicating that the command 806 has normally been received.

When HANAKO having received the mail logs in by presenting an ID card or by inputting a user name and/or a password, the MFP 102 performs a log-in process 808 and confirms that the log-in user is HANAKO, as in the log-in process 750.

Next, the MFP 102 logs in the presence server 105 by sending a REGISTER command 809. It should be noted that since the “use SIP URI of log-in user” checkbox 711 is checked for the MFP 102, the MFP 102 logs in by using the URI of hanako@abc.co.jp. If the “use the both” checkbox 712 is checked, the MFP 102 logs in by using both the log-in user name and the equipment name.

When a SUBSCRIBE command 810 is sent from the presence server 105, the MFP 102 sends back to the presence server 105 a response command 811 and a NOTIFY command 812 to which is attached online status information indicating a state where the user HANAKO has logged in.

When knowing that the status information has been updated and HANAKO has logged in, the presence server 105 sends to the MFP 100 a NOTIFY command 813 to notify that HANAKO is in a log-in state.

The MFP 100 sends back to the presence server 105 a response command 814 indicating that the command 813 has been received, and transmits image data 815 created in the scan process 801 to the MFP 102.

The MFP 102 receives the image data 815 and performs a printing process 816 to print the image data 815. When the user picks up printed sheets and logs out, the MFP 102 performs a log-out process 817.

After normally transmitting the data to the receiver machine during when the user has logged in, the MFP 100 performs a recording process 818 to record a transmission result (OK) in a log, together with transmission year/month/day/time, required transmission time, transmission destination, number of pages transmitted, transmission data size, log-in user (sender) name, etc. If the MFP 100 is set to print a transmission result report, the MFP 100 prints a transmission result report in which a reduced image of a top page is shown together with the above-described pieces of information.

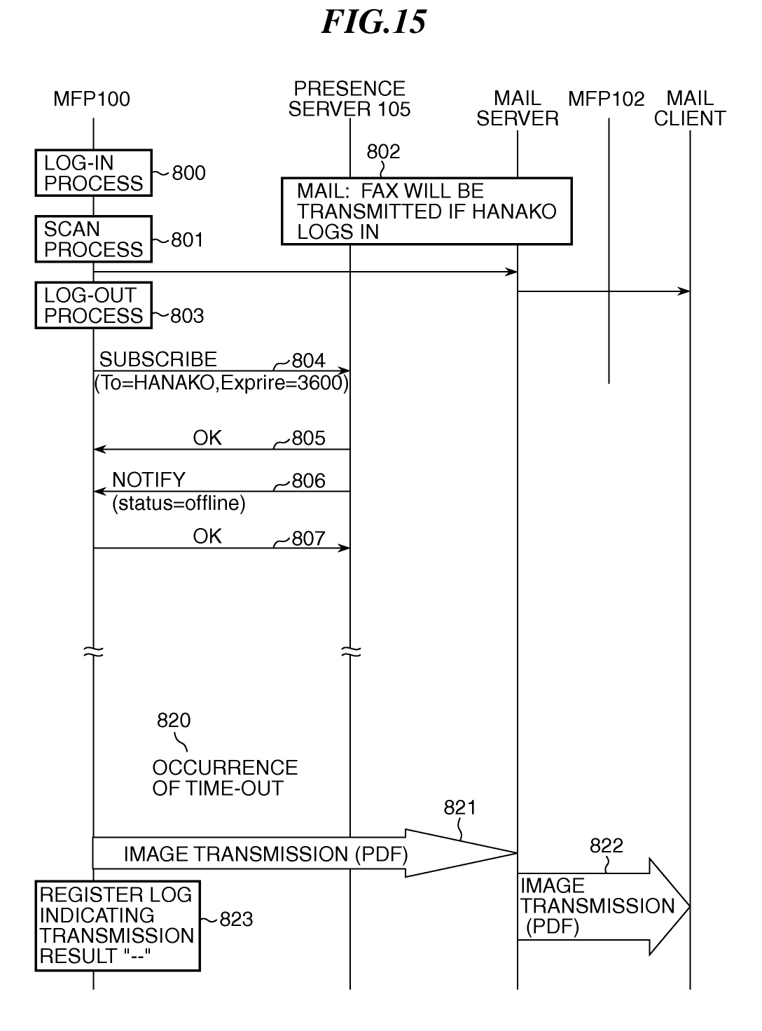

FIG. 15 shows in sequence diagram the procedures of image transmission in a case that the user address is set as destination information and the “user address” checkbox 702 of destination attribute is set ON as shown in FIG. 10B, and that a transmission time-out takes place when image data transmission is attempted.

From a log-in process 800 to transmission of a response command 807, the MFP 100 and the presence server 105 operate as previously described referring to FIG. 14.

If available time of 3600 seconds (=1 hour) specified by a SUBSCRIBE command 804 has elapsed without a recipient logging in the MFP 102, a time-out takes place as shown at 820. When the time-out takes place, the MFP 100 performs an image transmission process 821 to create a PDF file from an image obtained in the scan process 801 and transmit to a mail address of HANAKO an e-mail to which the PDF file is attached. The e-mail is transmitted from the MFP 100 to the mail server 106. The mail server 106 performs an image transmission process 822 to transmit the e-mail annexed with the image data to the mail client 107, which is set to be able to receive a mail directed to HANAKO.

In that case, the MFP 100 has transmitted the mail annexed with the image data to the mail client 107, but it is unknown for the MFP 100 whether the recipient who did not log in the MFP 102 got or will get the image data. Thus, the MFP 100 performs a recording process 823 to record a log indicating a transmission result “--” (unknown) together with transmission year/month/day/time, required transmission time, transmission destination, number of pages transmitted, transmission data size, log-in user (sender) name, etc. The registration of the log that requests the sender's attention is advantageous in that the sender is able to subsequently confirm, where necessary, with the recipient about whether he/she normally received the image data.

In the above example, the data transmission process 821 is performed to send an e-mail to the recipient's mail address when the time-out takes place. Alternatively, upon occurrence of the time-out, the MFP 100 is operable according to the setting of a selector switch for selecting e-mail transmission alternative to image data transmission or for selecting transmission or non-transmission of image data. If the MFP 100 is set to print a transmission result report, the MFP 100 prints a transmission result report in which a reduced image of a top page is shown together with the above-described pieces of information.

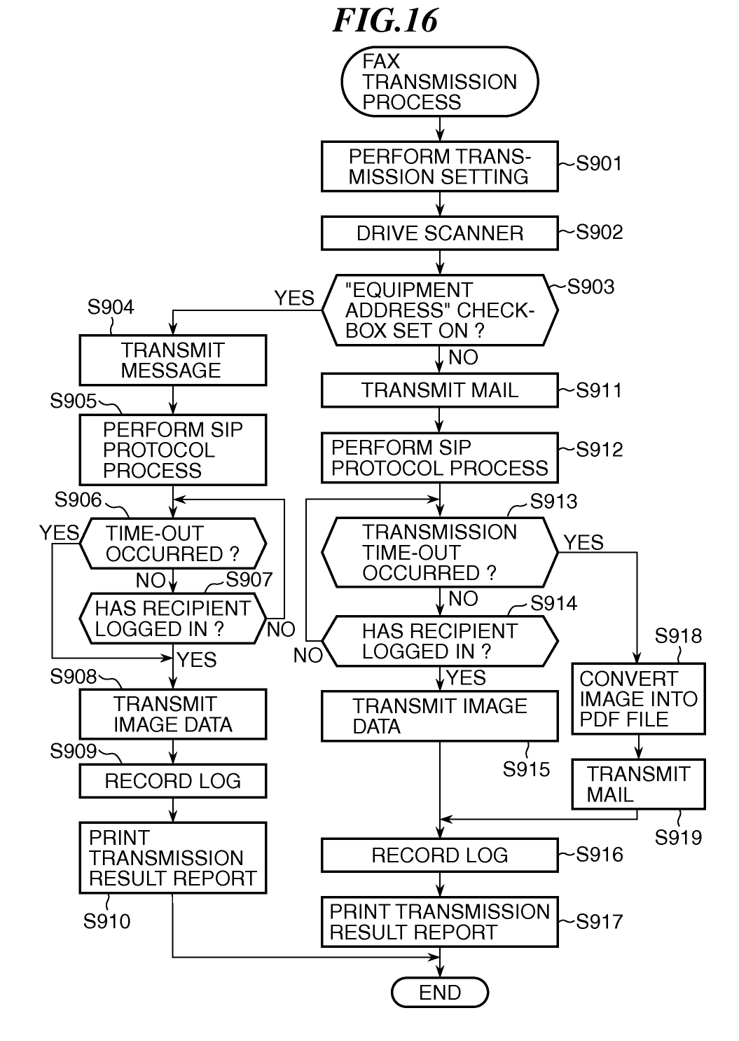

FIG. 16 shows in flowchart the procedures of a FAX transmission process performed by the sender MFP 100.

In S901 of the FAX transmission process, the MFP 101 performs a transmission setting process to designate a transmission destination and a scan setting process to set, e.g., the read size and resolution of the scanner 134. In S902, a scan process is performed to drive the scanner 134 to acquire image data.

In S903, it is determined whether the “equipment address” checkbox 711 is set ON in respect of attribute of transmission destination. If the answer to S903 is YES, the flow proceeds to S904, in which a message (corresponding to the massage in the message transmission 752 in FIG. 12) is transmitted to a receiver machine (e.g., MFP 102).

In S905, a SIP protocol process corresponding to from the transmission of SUBSCRIBE command 755 to the transmission of response command 758 in FIG. 12 is performed.

In S906, a time period from when the SUBSCRIBE command 755 is transmitted to when the NOTIFY command 765 notifying that the recipient user has logged in is received from the presence server 105 is measured. Then, whether the measured time period exceeds the available time of 3600 seconds and a time-out has occurred is determined. If a time-out has occurred, the flow proceeds to S908. If a time-out has not occurred, the flow proceeds to S907 to determine whether the MFP 100 has received the log-in notification command 765 from the presence server 105. If the MFP 100 has not received the command 765, the flow returns to S906. If the MFP 100 has received it, the flow proceeds to S908.

In S908, the MFP 100 transmits image data corresponding to the image data 767 in FIG. 12 by using T.38 protocol.

In S909, the MFP 100 records a log indicating a transmission result. If the image data has not normally been transmitted from the MFP 100, a transmission result “error” is recorded in the log. If the image data has normally been transmitted from the MFP 100 in a state where the user has logged in the receiver apparatus, a transmission result “OK” is recorded in the log. If the image data has normally been transmitted from the MFP 100 after occurrence of the time-out in a state where the recipient has not logged in the receiver apparatus, a transmission result “--” (unknown) is recorded in the log to request the sender's attention.

In S910, if a “print transmission result” setting has been made, the MFP 100 prints a transmission result report in which the transmission result and a reduced image of part of a top page of the transmitted image are indicated, whereupon the FAX transmission process of FIG. 16 is completed.

If the “user address” checkbox 702 is set ON and the transmission destination is represented by a user address, the answer to S903 becomes NO and the flow proceeds to S911. In S911, a mail transmission process is performed to transmit an e-mail stating that “FAX will be transmitted if HANAKO logs in” to a mail address designated in the address setting field 703, to thereby prompt the recipient to log in the receiver MFP.

In S912, a SIP protocol process corresponding to from the transmission of SUBSCRIBE command 804 to the transmission of response command 807 in FIG. 14 is performed.

In S913, a time period from when the SUBSCRIBE command 804 is transmitted to when the NOTIFY command 812 notifying that the transmission destination user has logged in is received from the presence server 105 is measured. Then, whether the measured time period exceeds the available time of 3600 seconds and a time-out takes place is determined. If a time-out takes place, the flow proceeds to S918.

In S918, the image read by the scanner 134 is converted into a PDF file. In S919, the PDF file created in S918 is transmitted to the e-mail address of the transmission destination designated in the address setting field 703. It should be noted that the transmitted file is not limited to a PDF file, but may be any file of any format (such as TIFF, JPEG, and XPS) able to be easily displayed on most PCs, without requiring special software to be installed.

After the e-mail transmission, a log is recorded in S916. At that time, a transmission result “--” to request sender's attention is recorded in the log, even if the e-mail has normally been transmitted. This is because instead of performing image data transmission to the user address, the e-mail has been transmitted to the mail address different from the user address (the original transmission destination) in a state where the recipient has not logged in. Subsequently, the flow proceeds to S917.

If it is determined in S913 that a transmission time-out has not occurred, the flow proceeds to S914 to determine whether the command 765 notifying that HANAKO has logged in has been received from the presence server 105. If the command 765 has not been received, the flow returns to S913. If the command 765 has been received, the flow proceeds to S915.

In S915, the image data obtained in the scan process in S902 is transmitted to the MFP 102 according to T.38 protocol.

In S916, since the image data has normally been transmitted during when the recipient user has logged in, a transmission result (OK) is recorded in a log together with transmission year/month/day/time, required transmission time, transmission destination, number of pages transmitted, transmission data size, log-in user (sender) name, etc. Subsequently, the flow proceeds to S917 to perform a transmission result report printing process, whereupon the FAX transmission process in FIG. 16 is completed.

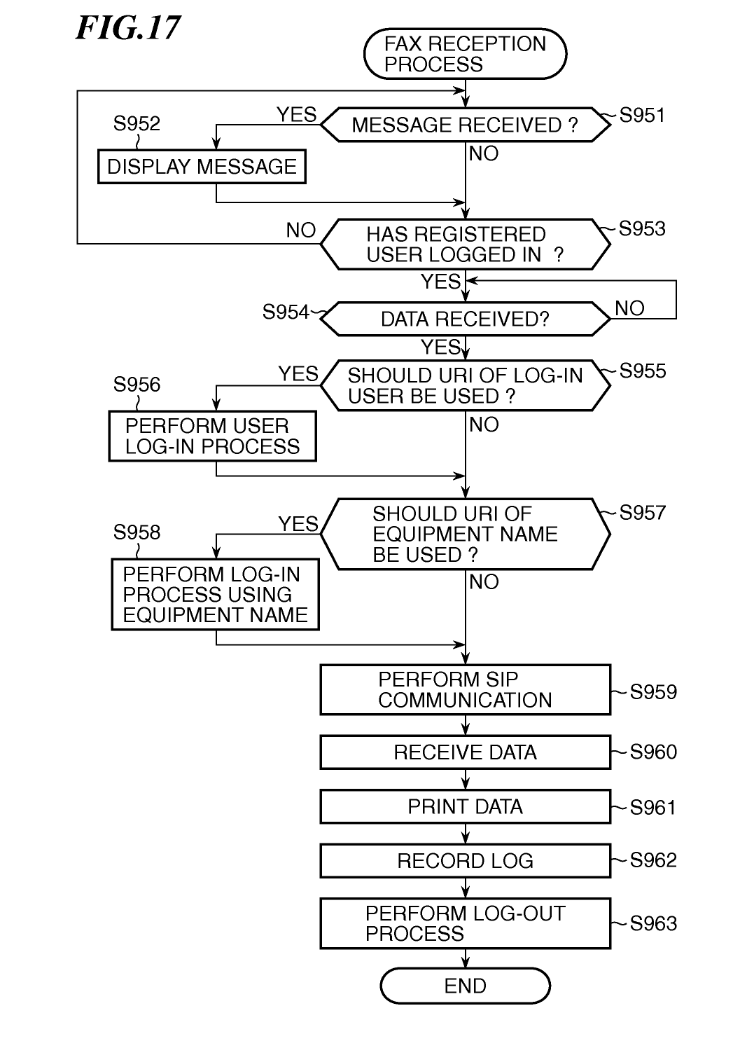

FIG. 17 shows in flowchart the procedures of a FAX reception process performed by the receiver MFP 102.

In S951 of the FAX reception process, whether a message (corresponding to the message in the message transmission 752) has been received is determined. If a message has been received, the flow proceeds to S952 where the received message is displayed on the operation unit 133 of the MFP 102.

Subsequently, when a user attempts to log in the MFP 102 by holding an ID card over the MFP 102 or by inputting a user name and/or a password via the operation unit 133, whether the user is a registered user is determined in S953. If it is determined that the user attempting to log in is a registered user, the flow proceeds to S954, in which whether image data transmitted by using T.38 has been received is determined. If image data has been received, the flow proceeds to S955 to determine whether a URI of the log-in user should be used to log in the presence server 105. To this end, whether either one of the “use SIP URI of log-in user” checkbox 710 and the “use the both” checkbox 712 is checked is determined. If either one of these checkboxes is checked, the flow proceeds to S956 to perform a user log-in process where the MFP 102 logs in the presence server 105 by sending the REGISTER command 809. At that time, the MFP 102 logs in by using the SIP RUI of HANAKO having logged in the MFP 102.

In S957, the MFP 102 determines whether the URI of the equipment name should be used to log in the presence server 105. To this end, whether either one of the “use equipment name” checkbox 711 and the “use the both” checkbox 712 is checked is determined. If either one of these checkboxes is checked, the flow proceeds to S958.

In S958, the MFP 102 logs in the presence server 105 by using the SIP URI of equipment name input to the field 713.

If the answer to S957 is NO or after the log-in process in S958 is performed, SIP communication of commands 762 to 764 is performed in S959.

In S960, image data is received according to T.38. The received data is printed in S961. In S962, log data such as reception result, number of pages received, sender information, required reception time, and print time is recorded. Subsequently, a log-out process is performed in S963, and the FAX reception process of FIG. 17 is completed.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-076591, filed Mar. 26, 2009, and Japanese Patent Application No. 2010-045434, filed Mar. 2, 2010, which are hereby incorporated by reference herein in their entirety.

What is claimed is:

1. An image communication apparatus comprising:
an input unit configured to input image data;
a designation unit configured to designate a recipient by whom the input image data is to be received;
a detection unit configured to detect, after the recipient is designated by said designation unit, that the designated recipient has logged in an external apparatus which is a transmission destination of the input image data; and
a transmission unit configured to transmit the input image data to the external apparatus in a case where said detection unit detects that the designated recipient has logged in the external apparatus.

2. The image communication apparatus according to claim 1, wherein said detection unit detects that the designated recipient has logged in the external apparatus based on a notification from a management server that manages a user's log-in state at the external apparatus.

3. The image communication apparatus according to claim 1, wherein said designation unit designates the recipient in accordance with a user's operation performed when said input unit inputs the image data.

4. The image communication apparatus according to claim 1, further including:
a setting unit configured to set whether the input image data should be transmitted on condition that said detection unit detects that the designated recipient has logged in the external apparatus or should be transmitted irrespective of whether said detection unit detects that the designated recipient has logged in the external apparatus,
wherein said transmission unit transmits the input image data in accordance with a setting by said setting unit.

5. The image communication apparatus according to claim 1, further including:
a first request unit configured to request, before said detection unit detects that the designated recipient has logged in the external apparatus, the external apparatus to output a message for notifying the designated recipient of presence of the input image data.

6. The image communication apparatus according to claim 1, further including:
a judgment unit configured to determine based on a processing ability of the external apparatus whether the external apparatus is able to normally process the input image data; and
a second request unit configured, in a case where said detection unit detects that the designated recipient has logged in the external apparatus and said judgment unit determines that the external apparatus is unable to normally process the input image data, to request the external apparatus to output a message for inquiring the log-in recipient whether the recipient wishes to receive the input image data by the external apparatus.

7. The image communication apparatus according to claim 1, wherein said transmission unit transmits the input image data by using session initiation protocol.

8. The image communication apparatus according to claim 1, wherein the image communication apparatus is connected to a plurality of external apparatuses including said external apparatus, and
said transmission unit transmits, in a case where said detection unit detects that the designated recipient has logged in any of the plurality of external apparatuses, the input image data to the external apparatus to which the recipient has logged in.

9. A control method of an image communication apparatus, comprising:
an input step of inputting image data;
a designation step of designating a recipient by whom the input image data is to be received;
a detection step of detecting, after the recipient is designated in said designation step, that the designated recipient has logged in an external apparatus which is a transmission destination of the input image data; and
a transmission step of transmitting the input image data to the external apparatus in a case where it is detected in said detection step that the designated recipient has logged in the external apparatus.

10. A computer-readable storage medium storing a program for causing a computer to execute the control method as set forth in claim 9.

11. An image communication apparatus comprising:
an input unit configured to input image data;
a designation unit configured to designate a recipient by whom the input image data is to be received;
a detection unit configured to detect that the designated recipient has logged in an external apparatus which is a transmission destination of the input image data;
a transmission unit configured to transmit image data; and
a log information recording unit configured to store a transmission result,
wherein in a case where image data has normally been transmitted to the designated recipient by said transmission unit, a log indicating successful transmission is recorded in said log information recording unit if said detection unit has detected that the recipient has logged in the external apparatus, and a log that requests a sender's attention is recorded in said log information recording unit if said detection unit has not detected that the recipient has logged in the external apparatus.

12. An image communication apparatus comprising:
an input unit configured to input image data;
a transmission destination designation unit configured to input a transmission address to which the input image data is to be transmitted, and configured to designate an attribute representing whether the transmission address is equipment address or user address;
a detection unit configured to detect that the designated recipient has logged in an external apparatus which is a transmission destination of the input image data; and
a transmission unit configured to transmit image data,
wherein in a case where said detection unit detects that a user has logged in, said transmission unit transmits the image data to an equipment address if the attribute designated by said transmission destination designation unit represents that the transmission address is equipment address, and transmits the image data to a user address if the attribute represents that the transmission address is user address.

13. The image communication apparatus according to claim 12, including:
an e-mail transmission unit; and
an e-mail address input unit configured, in a case where the attribute designated by said transmission destination designation unit represents that the transmission address is user address, to input a user's e-mail address,
wherein an e-mail for prompting the user to log in an image communication apparatus is transmitted to the user's e-mail address before transmission of the image data.

14. The image communication apparatus according to claim 12, including:
an e-mail transmission unit; and
an e-mail address input unit configured, in a case where the attribute designated by said transmission destination designation unit represents that the transmission address is user address, to input a user's e-mail address,
wherein in a case where said detection unit does not detect logging-in for a predetermined time period, an e-mail attached with the image data is transmitted to the user's e-mail address.

15. An image communication apparatus comprising:
a receiver unit configured to receive image data; and
a recipient user switching unit configured to set whether image data is to be received by using a URI of a log-in user or by using a URI of an equipment address,
wherein image data is received in accordance with a setting by said recipient user switching unit.

16. The image communication apparatus according to claim 15, wherein said recipient user switching unit is able to make a setting for receiving image data by using both the URI of the log-in user and the URI of the equipment address, and
in a case where use of both the URI of the log-in user and the URI of the equipment address is set by said recipient user switching unit, logging in is performed by using both the URI of the log-in user and the URI of the equipment address.
